(19) United States
(12) Patent Application Publication
(10) Pub. No.: US 2025/0376593 A1
(43) Pub. Date: Dec. 11, 2025

(54) APPLICATION OF POLYPHOSPHONATE HOMOPOLYMERS IN POLYMER BLENDS WITH IMPROVED IMPACT PROPERTIES AND THE METHODS RELATED THERETO

(71) Applicant: FRX Polymers, Inc., Chelmsford, MA (US)

(72) Inventors: Xiudong SUN, Weston, MA (US); Peter LOUVARIS, Medford, MA (US)

(73) Assignee: FRX Polymers, Inc., Chelmsford, MA (US)

(21) Appl. No.: 18/878,454

(22) PCT Filed: Jun. 21, 2023
(86) PCT No.: PCT/US2023/068814

§ 371 Date: Dec. 23, 2024

Related U.S. Application Data
(60) Provisional application No. 63/354,089, filed on Jun. 21, 2022.

(51) Int. Cl. C08L 87/00; C08G 81/00

(52) U.S. Cl. CPC C08L 87/005; C08G 81/00; C08L 2201/02

(57) ABSTRACT

Disclosed are reaction products of polyphosphonate homopolymers and other condensation polymers in the presence of catalysts in an extruder, methods of making such compounds. Also disclosed are fire resistant compositions employing such compounds as well as blends comprising such compounds.

### CROSS-REFERENCE RELATED APPLICATIONS

This application claims the benefit of priority to U.S. Provisional Patent Application 63/354,089, filed Jun. 21, 2022.

### BACKGROUND

Although polymers containing ester groups in the backbone are known to degrade hydrolytically in the presence of moisture at their typical melt processing temperatures, many compounders don't dry these polymers and other ingredients used in the formulation before compounding. Reasons can be many, such as added cost, a lack of existing dryers installed on production lines, or not optimal and yet acceptable product performance to their customers. Examples include the compounding of polycarbonate (PC) and its blends such as PC/ABS (Acrylonitrile butadiene styrene), PC/ASA (Acrylonitrile styrene acrylate), PC/PET (Polyethylene terephthalate), and PC/PBT (Polybutylene terephthalate).

It was observed that sometimes when polyphosphonate homopolymers were added into these systems without drying before compounding, there was loss in impact properties. For example, instead of 100% hinge break in notched izod (NI) testing when compounded dry, the NI would be 100% complete break (CB) when compounded undried, which results in much lower NI values. However, in addition to excellent flame retardancy, high impact properties or toughness are required in a wide range of applications from battery casings to the state-of-the-art medical devices.

Thus, compounds or compositions that could be used in an undried state prior to compounding, yet yield high impact properties or toughness are desirable.

### SUMMARY

Some embodiments provide a method of making a compound, comprising reacting a polyphosphonate homopolymer and at least one other condensation polymer in the presence of one or more catalysts in an extruder to yield the compound.

In some embodiments, the one or more catalysts comprise a metal ion in Group I and Group II.

In some embodiments, the one or more catalysts comprise a sodium cation containing substance. In some such embodiments, the level of metal ion is preferably below 100 ppm, more preferably below 50 ppm, and more preferably in the range of 5 and 15 ppm

In some embodiments, the reaction is carried out with dried materials

In some embodiments, the extrusion melt temperature is about 230 C to about 300 C.

In some embodiments, the resultant compound is a copolymer.

In some embodiments, the at least one condensation polymer is selected from PC, PET, PBT, PETG, PBS, PLA and other ester group containing polymers.

In some embodiments, the at least one other condensation polymer is PC.

In some embodiments, the PC has MFI of 20 or lower, preferably 12 or lower.

In some embodiments, the at least one other condensation polymer is PET.

In some embodiments, the at least one other condensation polymer is PBT.

In some embodiments, the at least one other condensation polymer is PETG.

Some embodiments provide, a blend comprising PET and the resulting compound.

Some embodiments provide a compound, wherein said compound is product made by the process of reacting polyphosphonate homopolymers and other condensation polymers in the presence of catalysts in an extruder.

Some embodiments provide a compound, wherein said compound comprises an extrusion reaction product of polyphosphonate homopolymers and at least one other condensation polymer in the presence of one or more catalysts.

Some embodiments provide a blend composition comprising the extrusion reaction product of polyphosphonate homopolymers and at least one other condensation polymer in the presence of one or more catalysts; and

One or more polymer resin having similar chemical structures with enhanced compatibility and properties.

Some embodiments provide a blend as above, wherein the extrusion reaction product is the reaction product of polyphosphonate homopolymers and PET in the presence of one or more catalysts, and the one or more polymer resin is a fire-resistant PC, or PC blend with high impact properties.

Some embodiments provide a blend as above, wherein the extrusion reaction product is the reaction product of polyphosphonate homopolymers and PET in the presence of one or more catalysts, and the one or more polymer resin is PETG.

Some embodiments provide a blend as above, wherein the extrusion reaction product is the reaction product of polyphosphonate homopolymers and PET in the presence of one or more catalysts, and the one or more polymer resin is PET.

Some embodiments provide a flame-retardant composition comprising ABS; and an extrusion reaction product of polyphosphonate homopolymers and at least one other condensation polymer in the presence of one or more catalysts. In some such embodiments, the at least one other condensation polymer is PET. In some embodiments, the at least one other condensation polymer is PBT. In some embodiments, the at least one other condensation polymer is PETG.

Some embodiments provide, compounds made in extruders by the reaction of polyphosphonate homopolymers and other condensation polymers in the presence of catalysts

In some embodiments, the catalysts are metal ion in Group I and Group II

In some embodiments, the catalysts are sodium cation containing substances

In some embodiments, the level of metal cation is preferably below 100 ppm, more preferably below 50 ppm, more preferably in the range of 5 and 15 ppm

In some embodiments, the reaction is carried out with dried materials

In some embodiments, the melt temperature is in the range of 230 C-300 C

In some embodiments, where the compounds are copolymers

In some embodiments, the condensation polymers are PC, PET, PBT, PETG (glycol-modified PET), PBS (Polybutylene succinate), PLA (polylatic acid) and other ester group containing polymers

Some embodiments provide blends comprising composition of a compound made in extruders by the reaction of polyphosphonate homopolymers and other condensation polymers in the presence of catalysts, and polymer resins having similar chemical structures with enhanced compatibility and properties. In some embodiments, the compounds are made from polyphophonate homopolymers and PC. In some embodiments, the PC has MFI (300 C/1.2 kg) of 20 or lower, preferably 12 or lower.

Some embodiments provide a fire-retardant PC, or PC blends with high impact.

In some embodiments, the copolymers are made from polyphosphonate homopolymers and PET.

Some embodiments provide a flame-retardant ABS-containing composition.

Blends comprising PET and the composition of a compound of embodiment 13.

In some embodiments, the copolymers are made from polyphosphonate homopolymers and PBT.

Some embodiments provide a flame-retardant ABS comprising.

In some embodiments, the copolymers are made from polyphosphonate homopolymers and PETG.

Some embodiments provide blends comprising PETG.

### BRIEF DESCRIPTION OF THE DRAWING FIGURES

FIG. 1a. is the DSC for example 211202-1

FIG. 1b. is the DSC for example 211202-2

FIG. 1c. is the DSC for polyphosphonate Nofia HM1100

FIG. 1d. is the DSC for DSC for polycarbonate Lexan 141R

### DETAILED DESCRIPTION

We have surprisingly discovered that a compound could be made from dried polyphosphonate homopolymer and PC in an extruder in the presence of catalyst, and this compound could then be used undried before compounding with additional polymers and additives to make flame retardant PC or PC blends with improved impact properties.

The method of making such compounds from polyphosphonate homopolymer and PC or PC blends in the presence of catalysts in an extruder could be extended beyond PC to other polymers such as, but not limited to, PET, PBT, PETG, PBS, PLA and other ester group containing polymers. The so made compounds could be used as compatibilizers in relevant blends with improved mechanical, optical and other properties.

### EXPERIMENTAL

### Materials

Nofia HM1100, HM9000, HM7000, HM5000—polyphosphonate homopolymers, FRX Polymers

Nofia CO6000—co(polyphosphonate-carbonate), FRX Polymers

Lexan 141R—Polycarbonate, Sabic Innovative Plastics

ColorFast®PC60—Polycarbonate, LTL Color Compounds

Tairilac AG1000—ABS, Formosa Chemicals & Fibre Corporation

Teflon® PTFE 6C—Polytetrafluoroethylene (PTFE), Chemours

Lotader 8900—impact modifier, SK Functional Polymers

Lotryl 29MA03T—impact modifier, SK Functional Polymers

Licomont® NaV 101—a sodium salt of montanic acids, Clariant

PALMSTAR NAV PC—sodium stearate, Peter Greven Nederland C.V.

### Compounding

A 27-millimeter twin screw extruder (TSE) with L/D of 40 was used to compound a variety of compositions of polycarbonate, Nofia polyphosphonates, PETs etc. The catalyst was not dried but all other ingredients were dried before compounding. The temperature for the extruder started at 200° C. at the feeding block, and the subsequent zones were set at different temperatures according to the resin systems. The compounding was conducted at 10-50 kgs/hour with a screw speed of 100-300 rpm.

### Testing

Notched Izod was conducted using izod pendulum impact tester Model 43-76 by TMI (Testing Machines Inc) according to ASTM D256. DSC (differential scanning calorimetry) was used to measure glass transition temperature (Tg) at 20 C/min in second heating.

### Results

Effect of moisture during compounding on impact properties of PC/Polyphosphonate blends

Table 1 shows the dramatic difference in impact properties between blends of PC with polyphosphonate homopolymer HM1100 when compounded undried vs. dried. It is 100% complete break (CB) for the undried vs. 0% CB (i.e. 100% hinge break) for the dried, and the average NI is 500-600% higher for the latter. Since most compounders don't dry materials before compounding for such blends, it is important to find a solution to increase the impact properties when polyphosphonate homopolymers are chosen as flame retardants.

TABLE 1
Comparison of compounding using dried
and undried polyphosphonate homopolymer

| | Undried before | | | Dried before | |
|---|---|---|---|---|---|
| | Compounding | | | Compounding | |
| | 220308-2 | 220308-1 | 220308-5 | 220215-2 | 220215-3 |
| PC, Lexan 141R | 67.3% | 72.3% | 72.3% | 75.18% | 77.18% |
| Polyphosphonate, HM1100 | 19.0% | 14.0% | 14.0% | 14.00% | 12.00% |
| Lotader AX8900 | 2.0% | 2.0% | | | |
| Lotryl 29MA03T | | | 2.0% | 2.00% | 2.00% |
| PTFE MB in PC, 3.4% | 11.7% | 11.7% | 11.7% | 8.82% | 8.82% |
| PTFE | 0.40% | 0.40% | 0.40% | 0.3% | 0.3% |
| P content, % | 2.00 | 1.47 | 1.47 | 1.47 | 1.26 |
| Notched Izod | | | | | |
| (NI) @ 3.2 mm | | | | | |
| Average, J/m | 90 | 120 | 150 | 700 | 730 |
| % CB/% Hinge break | 100/0 | 100/0 | 100/0 | 0/100 | 0/100 |

### Making Copolymer of PC and Polyphosphonates

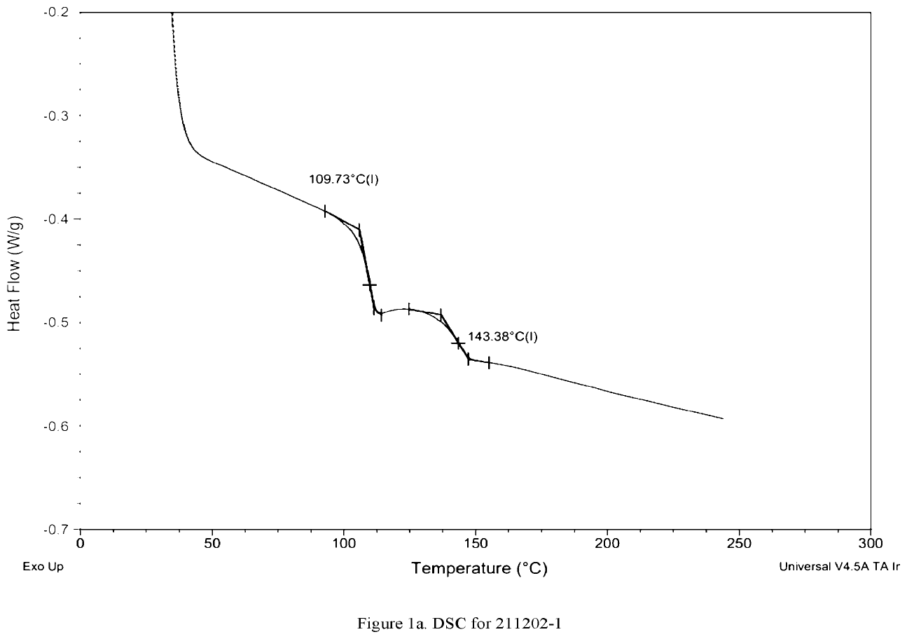

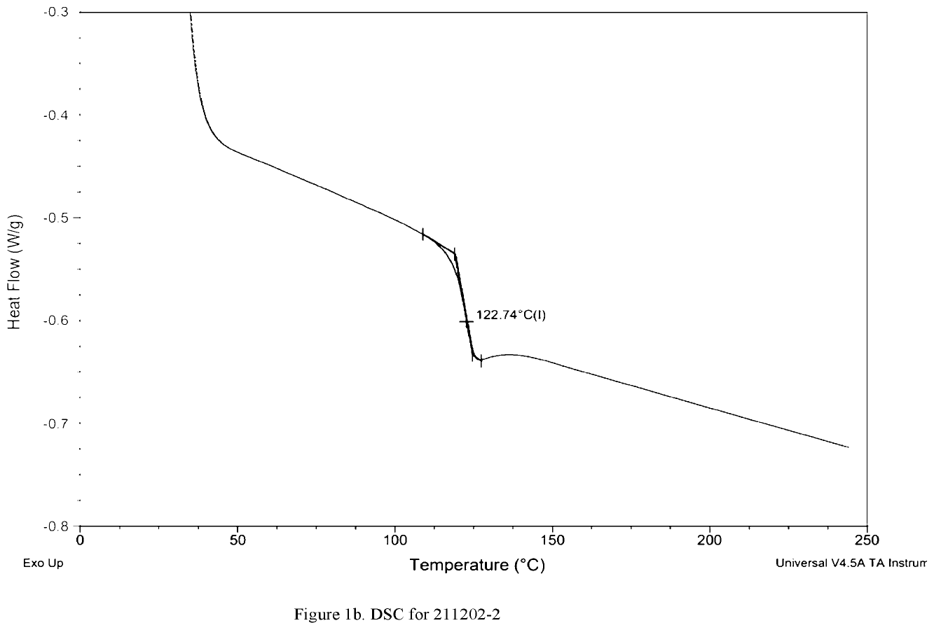

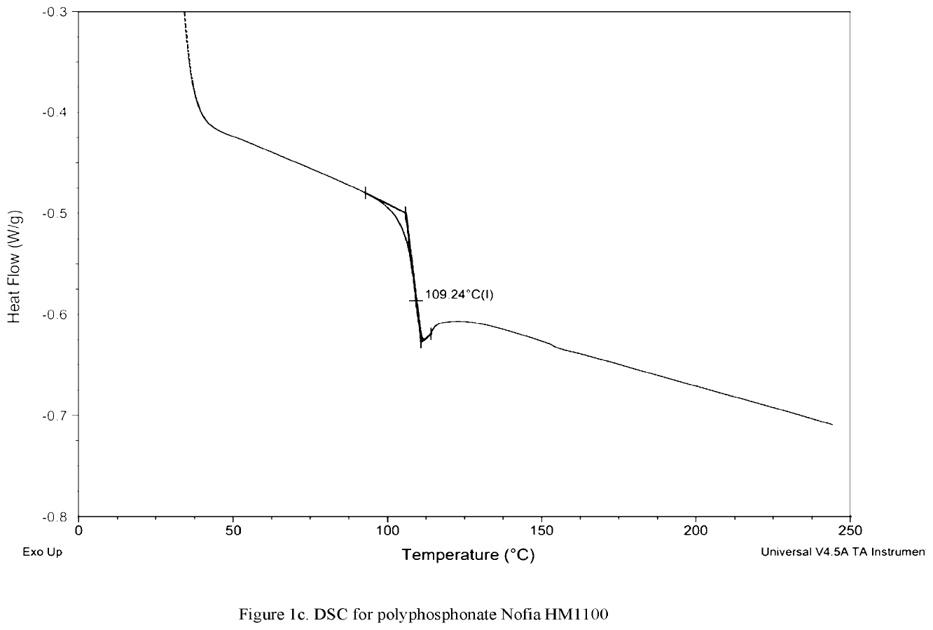

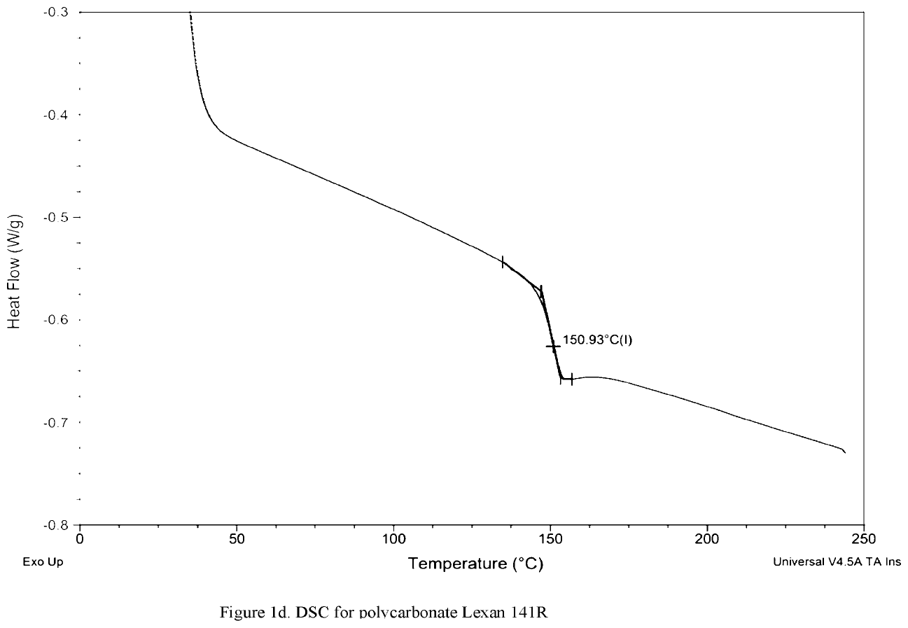

Table 2 shows the compositions of two compounds made in a twin screw extruder with and without catalyst (e.g. NaV 101), and FIG. 1 shows the DSC curves of the compounds as well as the individual polymers. As can be seen clearly, the control, 211202-1 made without NaV 101, has two Tgs corresponding to the Tg of polyphosphonate HM1100 and that of PC respectively. But 211202-2, which was made with NaV 101, shows one Tg at ˜ 123° C. This Tg is in good agreement with the calculated Tg of 124° C. from Fox equation as shown below, where Tg,A and Tg,B are glass transition temperatures for PC and HM1100 respectively.

$$1 / Tg , mix \approx wt \% , A / Tg , A + wt \% , B / Tg , B \qquad ( Fox equation )$$

The change from two Tgs of the individual polymers to one Tg of the compound 211202-2 is a clear indication of reaction between PC and polyphosphonate. Whether the formed copolymer is a block copolymer or random copolymer depends on the extend of the reaction which is a function of time, temperature and catalyst level.

TABLE 2
Compounding of PC with HM1100 in the presence of NaV 101

| | Drying, desiccant | | |
|---|---|---|---|
| | dryer | 211202-1 | 211202-2 |
| PC, Lexan 141R | 110 C. overnight | 40.00% | 39.95% |
| Polyphosphonate | 95 C. overnight | 60.00% | 60.00% |
| HM1100 | | | |
| NAV 101 | | | 0.05% |
| Total (%, kg) | | 100% | 100% |

| | |
|---|---|
| Compounding | Feed to die: 200/275/275/275/275/275/275/275 C. |
| temperatures | |

The copolymer 211202-2 in Table 2 was then compounded to make a flame retardant PC formulation as shown in Table 3. All ingredients used were not dried before compounding, including PC. Table 3 clearly shows the improvement in NI, e.g. 220405-2 made with undried copolymer, has 200-300% higher NI compared to compounds made with undried HM1100. But the control 220425-5, made with HM1100 and NaV 101 directly compounded into the formulation, showed low impact properties, indicating the importance of forming the copolymer before being compounded undried.

The single Tg formed as a result of reaction should also increase the heat aging stability of the blend, which is often determined by the lowest Tg of the individual polymer in the blend, as the single Tg is higher than the lowest Tg. For the same reason, the HDT of the blend should also be higher.

TABLE 3
FR PC comparison

| | Undried before | | | | | Dried before | |
|---|---|---|---|---|---|---|---|
| | Compounding | | | | | Compounding | |
| | 220308-2 | 220308-1 | 220308-5 | 220405-2 | 220425-5 | 220215-2 | 220215-3 |
| PC Lexan 141R | 67.3% | 72.3% | 72.3% | 63.1% | 72.294% | 75.18% | 77.18% |
| Nofia HM1100 | 19.0% | 14.0% | 14.0% | | 14.000% | 14.00% | 12.00% |
| 211202-2 | | | | 23.2% | | | |
| Lotader AX8900 | 2.0% | 2.0% | | 2.0% | 2.000% | | |
| Lotryl 29MA03T | | | 2.0% | | | 2.00% | 2.00% |
| NaV 101 | | | | | 0.006% | | |
| PTFE MB in PC, | 11.7% | 11.7% | 11.7% | 11.7% | 11.700% | 8.82% | 8.82% |
| 3.4% | | | | | | | |
| PTFE | 0.40% | 0.40% | 0.40% | 0.40% | 0.40% | 0.30% | 0.30% |
| P content, % | 2.00 | 1.47 | 1.47 | 1.46 | 1.47 | 1.47 | 1.26 |
| Compounding | From feed to die: 200/265/265/265/260/260/260/260 C. | | | | | | |
| temperatures, C. | | | | | | | |
| NI @ 3.2 mm | | | | | | | |
| Average, J/m | 90 | 120 | 150 | 400 | 130 | 700 | 730 |
| % CB/% Hinge | 100/0 | 100/0 | 100/0 | 50/50 | 100/0 | 0/100 | 0/100 |

### Effect of Molecular Weight of PC

Instead of using Lexan 141R which has MFI of 10.5 to make the copolymer (e.g., Table 2), PC60 with MFI of 6 was used to make the copolymer as shown in Table 4 below. These copolymers were then compounded undried to make FR PC formulation shown in Table 5. The data clearly demonstrated that the increase of MW of PC further increases the impact properties of the FR PC blends. The high MW PC could be used to make the copolymers or the FR PC blends at the point of compounding. 100% hinge break could be achieved with high MW PC for FR PC blends based on polyphosphates.

The control, 220413-5, which was made with the mixture of PC/HM1100 without NaV 101 (220412-3), showed low impact properties, indicating the importance of catalyst to promote reaction to form the copolymer.

TABLE 4
Copolymers Made with Higher MW PC

| Sample ID | Drying | 220412-1 | 220412-2 | 220412-3 | 220526-4 |
|---|---|---|---|---|---|
| PC, ColorFast ®PC60 | 110 C. overnight | 39.975% | 39.95% | 40% | 37.975% |
| Nofia HM1100 | 95 C. overnight | 60.000% | 60.00% | 60% | |
| Nofia HM7000 | 95 C. overnight | | | | 62% |
| NAV 101 | | 0.025% | 0.05% | | 0.025% |
| Total (%, kg) | | 100% | 100% | 100% | 100% |

TABLE 5
Effect of MW of PC on Impact Properties of FR PC

| Sample ID | 220413-2 | 220413-3 | 220413-4 | 220413-5 | 220405-2 | 220425-4 |
|---|---|---|---|---|---|---|
| PC, ColorFast ®PC60 | 63.10% | 63.10% | 63.10% | 63.10% | | |
| PC, Lexan 141 R | | | | | 63.10% | 63.10% |
| 220412-2 (0.05% NaV | 23.20% | | | | | |
| 101, PC60) | | | | | | |
| 220412-1 (0.025% NaV | | 23.20% | | | | 23.20% |
| 101, PC60) | | | | | | |
| 211202-2 (0.05% NaV | | | 23.20% | | 23.20% | |
| 101, Lexan 141R) | | | | | | |
| 220412-3 (0% NaV, PC60) | | | | 23.20% | | |
| AX8900 | 2.00% | 2.00% | 2.00% | 2.00% | 2.00% | 2.00% |
| PTFE MB 3.4% | 11.70% | 11.70% | 11.70% | 11.70% | 11.70% | 11.70% |
| Total (%) | 100.00% | 100.00% | 100.00% | 100.00% | 100.00% | 100.00% |
| P content | 1.462% | 1.462% | 1.462% | 1.462% | 1.462% | 1.462% |
| NI@3.2 mm | | | | | | |
| average, J/m | 650 | 670 | 680 | 130 | 400 | 640 |
| % CB/% hinge break | 0/100 | 0/100 | 0/100 | 100/0 | 50/50 | 0/100 |

### Effect of Catalyst Level

To determine the minimum level of catalyst needed to make a copolymer and its effect on impact properties of subsequent blends, a DOE was conducted as shown in Table 6. 40 lbs/hr at rpm of 200 were used in this DOE. The torque was found increasing with the catalyst level during compounding. Tg of the compounds as well as Yellowness Index (YI) were measured. At low level of catalyst such as 0.005%, the compound still has two Tgs. But as the catalyst level increased, the two Tgs became one and plateaued out at 121° C. Rate of reaction could also be a function of the type of PC used, the residence of the materials in the extruder, melt temperature, etc. The optimal level of catalyst needed to make a copolymer should therefore be determined accordingly so the copolymer provides good impact properties to the blends made with undried ingredients. Since increased level of NaV 101 increases YI, it is ideal to use just right amount for the benefit of improving impact properties.

The copolymers made in Table 6 were compounded with PC undried and impact properties were measured, as shown in Table 7.

Catalysts used in this invention are not limited to NaV 101. Any metal cation from Group I and Group II that are stable at the processing temperature could be used. The level of metal cation should not be too high as catalyst poisoning or side reaction may happen. Metal cation level of 100 ppm or below is preferred and as little as a few ppm (i.e. 5 ppm) could be sufficient.

TABLE 6
Copolymer Made with different levels of NaV 101

| Dried before | | | | |
|---|---|---|---|---|
| compounding | 220504-1 | 220504-2 | 220504-3 | 220504-4 |
| PC, ColorFast ®PC60 | 37.995% | 37.990% | 37.985% | 37.980% |
| Nofia HM1100 | 62.000% | 62.00% | 62.000% | 62.00% |
| NAV 101 | 0.005% | 0.010% | 0.015% | 0.020% |
| Total (%) | 100.000% | 100.000% | 100.000% | 100.000% |
| P content | 6.57% | | | |
| Compounding | From feed to die: | | | |
| Temperatures | 200/275/275/275/275/275/275/275° C. | | | |
| Torque (%) | 46 | 54 | 60 | 61 |
| Properties | | | | |
| Yellowness Index (YI) | 27 | 35 | 39 | 43 |
| Tg, 1, ° C. | 109 | 119 | 121 | 121 |
| Tg, 2, ° C. | 141 | | | |

TABLE 7
FR PC, compounded undried

| | 220517-1 | 220517-2 | 220517-3 | 220425-4 |
|---|---|---|---|---|
| PC, Lexan 141R | 61.30% | 63.30% | 61.30% | 63.10% |
| 220504-3 | | 23.00% | 25.00% | |
| (0.015% NaV 101) | | | | |
| 220504-4, | 25.00% | | | |
| (0.020% NaV 101) | | | | |
| 220412-1, | | | | 23.20% |
| (0.025% NaV 101) | | | | |
| Lotader AX8900 | 2.00% | 2.00% | 2.00% | 2.00% |
| PTFE MB 3.4% | 11.70% | 11.70% | 11.70% | 11.70% |
| Total, % | 100% | 100% | 100% | 100% |
| P content, % | 1.63% | 1.50% | 1.63% | 1.51% |
| NI@3.2 mm | | | | |
| average, J/m | 600 | 650 | 650 | 640 |
| % CB/% hinge | 20/80 | 10/90 | 10/90 | 0/100 |

### Copolymer Used Undried to Make FR PC/ABS

The copolymers made according to this invention could be used in other PC blends such as PC/ABS as shown in Table 8 shows. High impact property was achieved for copolymers made from both HM1100 and HM7000 homopolymers. Such FR PC/ABS blends also have high HDT, due to the high Tg of polyphosphonate used.

TABLE 8
FR PC/ABS, compounded undried

| | 220428-1 | 220428-2 | 220607-5 |
|---|---|---|---|
| PC Lexan 141R | 62.05% | 62.05% | 62.05% |
| Nofia CO6000 | 25.00% | | |
| Copolymer, 220412-2 | | 25.00% | |
| (PC/HM1100) | | | |
| Copolymer, 220526-4 | | | 25.00% |
| (PC/HM7000) | | | |
| ABS Tairilac AG1000 | 10.00% | 10.00% | 10.00% |
| Lotader AX8900 | 2.50% | 2.50% | 2.50% |
| PTFE, 6C | 0.45% | 0.45% | 0.45% |
| Total | 100% | 100% | 100% |
| P content, % | 1.63% | 1.59% | 1.63% |
| Compounding | From feed to die: | | |
| temperatures | 200/240/240/240/250/250/250/250° C. | | |
| NI @3.2 mm | | | |
| average, J/m | 790 | 760 | 760 |
| % CB/% hinge | 0/100 | 0/100 | 0/100 |

### Effect of Compounding Temperature, Moisture on the Copolymer

To study how the compounding conditions affect the copolymer, the following experiment as shown in Table 9 was conducted where the materials were undried and lower temperature was used for compounding. DSC showed both compounds have two Tgs that correspond to polyphosphonate and PC, indicating little reaction to form the copolymers.

Compounds made in Table 9 were then compounded undried to make FR PC formulations as shown in Table 10. The notched izod impact properties are back to the values when homopolymer HM1100 was used undried, indicating the importance of making the copolymer under dried conditions and at high temperatures.

The current invention could be carried in two steps as described above, i.e. first making the compound or copolymer by reacting polyphosphonate homopolymer and a condensation polymer in the presence of catalyst, and then in second step making a composition comprising the made compound or copolymer and other polymers with compatible chemical structures. The invention could also be carried out in one step in a twin screw extruder (TSE) with long L/D, where polyphosphonate homopolymer reacts with a condensation polymer at the beginning of the extruder, either pre-dried, or the moisture removed by the vacuum port on the TSE, in the presence of catalyst, followed by other polymers or ingredients added through the side feeders downstream undried to make desired composition.

TABLE 9
Making the copolymer at low temperature with undried materials

| Sample ID | Drying | 220420-1 | 220420-3 |
|---|---|---|---|
| PC, ColorFast ®PC60 | undry | 37.975% | 37.990% |
| Nofia, HM1100 | undry | 62.000% | 62.000% |
| NAV 101 | undry | 0.025% | 0.010% |
| Total, % | | 100.000% | 100.000% |
| P content | | 6.57% | |
| Compounding | From feed to die: | | |
| Temperatures | 200/235/235/235/230/230/230C/230° C. | | |
| Tg, 1° C. | | 107 | 107 |
| Tg, 2° C. | | 144 | 144 |

TABLE 10
FR PC, compounded undried

| | 220425-1 | 220425-2 | 220425-3 |
|---|---|---|---|
| PC, ColorFast ®PC60 | 64.0% | 64.0% | |
| PC, Lexan 141R | | | 64.0% |
| 220420-3 (undry, low temp, | 22.3% | | |
| 0.010% NaV 101) | | | |
| 220420-1 (undry, low temp, | | 22.3% | 22.3% |
| 0.025% NaV 101) | | | |
| Lotader AX8900 | 2.0% | 2.0% | 2.0% |
| PTFE MB 3.4% | 11.7% | 11.7% | 11.7% |
| Total | 100.0% | 100.0% | 100.0% |
| NI @3.2 mm | | | |
| average, J/m | 120 | 120 | 110 |
| % CB/% hinge | 100/0 | 100/0 | 100/0 |

### Exemplary Embodiments

A method of making a compound, comprising:
reacting a polyphosphonate homopolymer and at least one other condensation polymer in the presence of one or more catalysts in an extruder to yield the compound.

The method of embodiment 1, wherein the one or more catalysts comprise a metal ion in Group I and Group II.

The method of embodiment 2 wherein the one or more catalysts comprise a sodium cation containing substance.

The method of embodiment 2 wherein the level of metal ion is preferably below 100 ppm, more preferably below 50 ppm, and more preferably in the range of 5 and 15 ppm

The method of embodiment 1 to 4 wherein the reaction is carried out with dried materials

The method of embodiment 5 wherein the melt temperature is about 230 C to about 300 C.

The method of embodiments 1-6 where the compound is a copolymer.

The method of embodiment 1 wherein the at least one condensation polymer is selected from PC, PET, PBT, PETG, PBS, PLA and other ester group containing polymers.

The method of embodiments 1-8 wherein the at least one other condensation polymer is PC.

The method of embodiment 9 wherein the PC has MFI of 20 or lower, preferably 12 or lower.

The method of embodiment 1-8 wherein the at least one other condensation polymer is PET.

The method of embodiment 1-8 wherein the at least one other condensation polymer is PBT.

The method of embodiment 1-8 wherein the at least one other condensation polymer is PETG.

A blend comprising PET and the composition of a compound of embodiment 11.

A compound, wherein said compound is product made by the process of:
reacting polyphosphonate homopolymers and other condensation polymers in the presence of catalysts in an extruder.

A compound, wherein said compound comprises an extrusion reaction product of polyphosphonate homopolymers and at least one other condensation polymer in the presence of one or more catalysts.

A blend composition comprising:
the extrusion reaction product of polyphosphonate homopolymers and at least one other condensation polymer in the presence of one or more catalysts; and
One or more polymer resin having similar chemical structures with enhanced compatibility and properties.

The blend of embodiment 19, wherein
the extrusion reaction product is the reaction product of polyphosphonate homopolymers and PET in the presence of one or more catalysts, and
the one or more polymer resin is a fire resistant PC, or PC blend with high impact properties.

The blend of embodiment 19, wherein
the extrusion reaction product is the reaction product of polyphosphonate
homopolymers and PET in the presence of one or more catalysts, and
the one or more polymer resin is PETG.

The blend of embodiment 19, wherein
the extrusion reaction product is the reaction product of polyphosphonate homopolymers and PET in the presence of one or more catalysts, and
the one or more polymer resin is PET.

A flame retardant composition comprising: ABS; and
an extrusion reaction product of polyphosphonate homopolymers and at least one other condensation polymer in the presence of one or more catalysts.

The flame retardant compositions of embodiment 27, wherein:
the at least one other condensation polymer is PET.

The flame retardant compositions of embodiment 27, wherein:
the at least one other condensation polymer is PBT.

The flame retardant compositions of embodiment 27, wherein:
the at least one other condensation polymer is PETG.

Applicant is not limited to the embodiments disclosed herein. These and other embodiments will be readily apparent to one of ordinary skill in light of this specification without departing from the scope and spirit of this disclosure.

What is claimed is:

1. A method of making a compound, comprising:
reacting a polyphosphonate homopolymer and at least one other condensation polymer in the presence of one or more catalysts in an extruder to yield the compound.

2. The method of claim 1, wherein the one or more catalysts comprise a metal ion in Group I and Group II.

3. The method of claim 2 wherein the one or more catalysts comprise a sodium cation containing substance.
a. The method of claim 2 wherein the level of metal ion is preferably below 100 ppm, more preferably below 50 ppm, and more preferably in the range of 5 and ppm

4. The method of claims 1 to 4 wherein the reaction is carried out with dried materials

5. The method of claim 5 wherein the melt temperature is about 230 C to about 300 C.

6. The method of claims 1-6 where the compound is a copolymer.

7. The method of claim 1 wherein the at least one condensation polymer is selected from PC, PET, PBT, PETG, PBS, PLA and other ester group containing polymers.

8. The method of claims 1-8 wherein the at least one other condensation polymer is PC.

9. The method of claim 9 wherein the PC has MFI of 20 or lower, preferably 12 or lower.

10. The method of claim 1-8 wherein the at least one other condensation polymer is PET.

11. The method of claim 1-8 wherein the at least one other condensation polymer is PBT.

12. The method of claim 1-8 wherein the at least one other condensation polymer is PETG.

13. A blend comprising PET and the composition of a compound of claim 11.

14. A compound, wherein said compound is product made by the process of:
reacting polyphosphonate homopolymers and other condensation polymers in the presence of catalysts in an extruder.

15. A compound, wherein said compound comprises an extrusion reaction product of polyphosphonate homopolymers and at least one other condensation polymer in the presence of one or more catalysts.

16. A blend composition comprising:
a. the extrusion reaction product of polyphosphonate homopolymers and at least one other condensation polymer in the presence of one or more catalysts; and
b. One or more polymer resin having similar chemical structures with enhanced compatibility and properties.

17. The blend of claim 19, wherein
a. the extrusion reaction product is the reaction product of polyphosphonate homopolymers and PET in the presence of one or more catalysts, and
b. the one or more polymer resin is a fire resistant PC, or PC blend with high impact properties.

18. The blend of claim 19, wherein
a. the extrusion reaction product is the reaction product of polyphosphonate homopolymers and PET in the presence of one or more catalysts, and
b. the one or more polymer resin is PETG.

19. The blend of claim 19, wherein
a. the extrusion reaction product is the reaction product of polyphosphonate homopolymers and PET in the presence of one or more catalysts, and
b. the one or more polymer resin is PET.

20. A flame retardant composition comprising:
a. ABS; and
b. an extrusion reaction product of polyphosphonate homopolymers and at least one other condensation polymer in the presence of one or more catalysts.

21. The flame retardant compositions of claim 27, wherein:
a. the at least one other condensation polymer is PET.

22. The flame retardant compositions of claim 27, wherein:
a. the at least one other condensation polymer is PBT.

23. The flame retardant compositions of claim 27, wherein:
a. the at least one other condensation polymer is PETG.
